(19) United States
(12) Patent Application Publication
(10) Pub. No.: US 2007/0203754 A1
(43) Pub. Date: Aug. 30, 2007

(54) Network health record and repository systems and methods

(76) Inventors: David Glenn Harrington, Modesto, CA (US); Niamh M. Harrington, Modesto, CA (US); James Timothy Freeman JR., Stockton, CA (US); Martin Robert Fisher, Altadena, CA (US); Jason Edward Krohn, Turlock, CA (US); Jorge Mario Mercado, Manteca, CA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/657,827

(22) Filed: Jan. 25, 2007

Related U.S. Application Data
(60) Provisional application No. 60/762,467, filed on Jan. 26, 2006.

(51) Int. Cl. G06F 19/00

(52) U.S. Cl. 705/3

(57) ABSTRACT

Methods and systems for healthcare information management. One system according to one embodiment of the present invention for managing a patient's healthcare information at a plurality of locations, said system comprising: a plurality of facilities where the patient's healthcare information is stored; a repository and management system; wherein said repository and management system enables the patient to manage the patient's healthcare information stored at the plurality of facilities. One embodiment uses federated identity and access management to develop a dynamic topology using indexes of patient data at other sites.

### CROSS-REFERENCE TO RELATED APPLICATIONS

This document claims the benefit of U.S. Provisional Patent Application Ser. No. 60/762,467, entitled “Network Health Record and Repository Systems and Methods” and filed Jan. 26, 2006, the entire contents of which are hereby incorporated by this reference.

### FIELD OF THE INVENTION

The present invention relates generally to resource and record management and, more particularly, methods and systems for health care record and resource management. The invention disclosed herein provides for the creation, maintenance, and management of a Network Health Record by the patient or under the control, direction, and authorization of the patient.

### BACKGROUND

Research shows that most people want convenient access to their health information. As computers and the Internet continue to become more pervasive, and as security technology improves, demand for electronic access to patient-centric medical data will increase. However, the current problem in healthcare is that a patient's healthcare records are distributed across many different islands of information. Traditionally, clinical observation has been a paper-based system and it has been very difficult to move beyond that model in healthcare to an automated, network-based system. The Medic Alert Foundation (“MedicAlert”) has been holding a form of medical information for its members electronically since the early 1970s. As the industry moves to a more acute awareness of the benefits of automation, MedicAlert currently provides a solution to the problem of centrally holding information from disparate sources in a central repository.

A problem that arises, however, is how to provide access to the right information at the right time and at the right place to the right person. A patient's healthcare record contains information from more than one source. Individual healthcare records are stored in and retrieved from many different information systems, such as physician offices, hospital systems, insurance carrier claims databases, pharmacy and medical laboratory systems, point-of-care clinics, patient financial services and others. A patient's records from one system will be maintained and contained in that system. However, if that patient changes providers or changes insurance plans and now sees new doctors at a new office and is serviced in a different hospital, the records from the new doctor or the new hospital will not always be coordinated with the older records. Thus, the problem is that a complete historical view of a patient's care no matter where the patient received care does not exist.

### SUMMARY

Embodiments of the present invention provide methods and systems for healthcare information management. One system according to one embodiment of the present invention comprises a system for managing a patient's healthcare information at a plurality of locations, comprising a plurality of facilities where the patient's healthcare information is stored, a repository and management system, a communications network providing communications capability among and between the plurality of facilities and the repository and management system, wherein the repository and management system enables the patient to manage the patient's healthcare information stored at the plurality of facilities. One embodiment uses federated identity and access management to develop a dynamic topology using indexes of patient data at other sites.

### BRIEF DESCRIPTION OF THE DRAWINGS

These and other features, aspects, and advantages of the present invention are better understood when the following Detailed Description is read with reference to the accompanying drawings, wherein:

FIG. 1 illustrates a system architecture according to one embodiment of the present invention;

FIG. 2 illustrates the high-level components of the Network Health Record System according to one embodiment of the present invention;

FIG. 3 illustrates the elements stored in the repository that support the Network Health Record (NHR) as well as an overview of the federated identity and access management according to one embodiment of the present invention;

FIG. 4 illustrates the functionality of the NHR according to one embodiment of the present invention;

FIG. 5 illustrates how a NHR is created according to one embodiment of the present invention; and

FIG. 6 illustrates how a client retrieves PHI details from a NHR according to one embodiment of the present invention.

### DETAILED DESCRIPTION

### Introduction and the Network Health Record System

One embodiment of the present invention utilizes a networked patient-centered electronic health record (EHR), or Network Health Record (NHR), within a Networked Health Record System to permit a patient to manage his or her health records. The NHR includes a collection of individual records and references to individual records that reside in a variety of information systems and locations and on multiple types of media. An associated NHR Engine may be provided to enable access to these distributed records. The NHR contains information that is primarily provided by and with the authorization of the member, or patient, and from many health-related encounters. These records collectively reflect the current health status and lifetime medical history of an individual. The NHR is “networked” in the sense that the healthcare information does not necessarily reside in one place. Individual healthcare records are stored in and retrieved from many information systems, such as physician offices, hospital systems, insurance carrier claims databases, pharmacy and medical laboratory systems, point-of-care clinics, patient financial services and others. Additionally, some components of the patient-centered NHR are in enterprise-wide data, voice, and image repositories. The patient-centered NHR does not gather and store health related data from disparate sources; therefore it avoids the extensive cost and complexity involved in establishing and maintaining large warehouses of information.

The NHR differs from an EHR stored at a central repository in that the information is sourced from significantly different locations, which necessitates an approach to creating, managing, maintaining, and accessing the information in a way that accounts for the distributed nature of the actual information storage. The NHR is a patient-centric record for which in one embodiment the patient ultimately determines who may have access and to whom Patient Healthcare Information (PHI) may be released. A centralized repository and management system (RMS), interacts with an information requester as well as the various sites and systems from which the information is sourced, and provides a platform for the patient to manage the NHR. The RMS includes the NHR Engine and enables the patient whose information is being managed to provide secure access to the appropriate healthcare information through the granting (or denying) of permissions to physicians, hospital personnel, laboratory personnel, insurance claims personnel, etc.

The information flow between each node in the network is routed through the RMS (which in one embodiment is the MedicAlert Repository System (MARS)), which provides services for the collection, summarization, categorization, classification and communication of the information based on the patient's authorization profile. Moreover, in processing a request for information, the NHR Engine, after ascertaining that the requester has the appropriate permissions, identifies the locations of the requested information, assembles the information, and integrates the possibly disparate formats in which the information may be presented to the requester as an integrated package. A NHR Index may be stored in the RMS that may contain summary personal health information and links to the more complete personal health information located at the source node.

### System Architecture

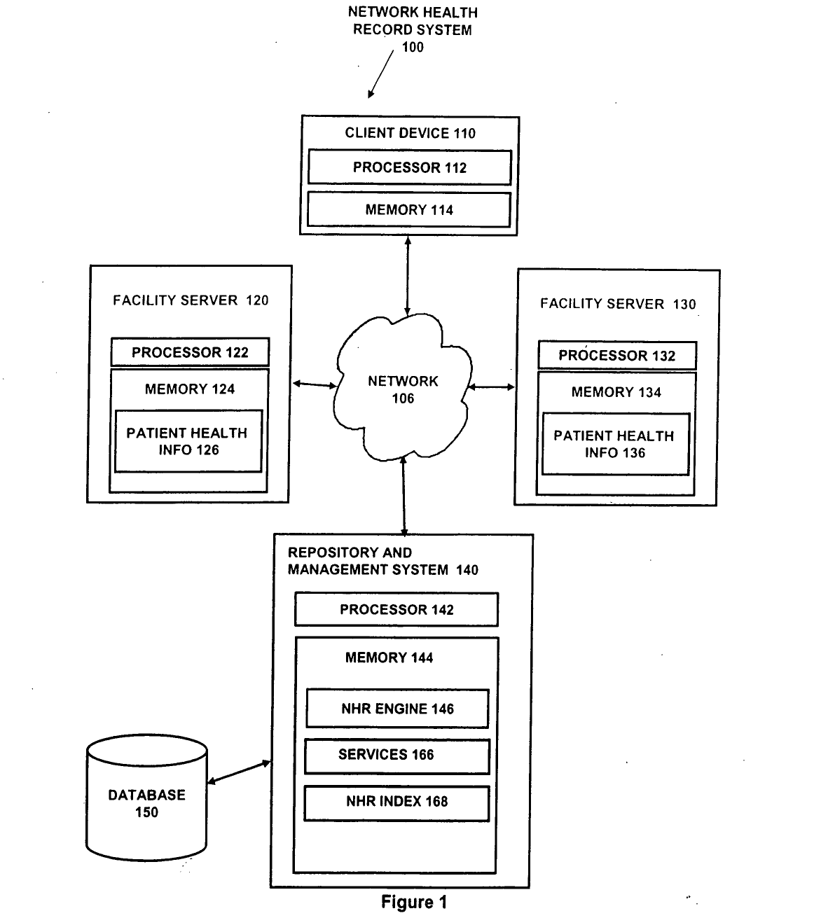

One purpose of the NHR System is to allow for the creation and management of a NHR. FIG. 1 is a block diagram showing an illustrative environment for a peer to peer implementation of one embodiment of the NHR System 100. The NHR System 100 shown in FIG. 1 comprises a client device 110, facility servers 120 and 130, and a Repository and Management System (RMS) 140 including a NHR Engine 146 and a NHR Index 168 connected over a network 106.

Members and healthcare professionals can use client devices 110 to access data through the RMS 140 via a user interface. In one embodiment, a client device 110 may connect to the RMS 140 via a network 106, such as the Internet. The network 106 may also comprise an intranet, a Local Area Network (LAN), a telephone network, or a combination of suitable networks. The client device 110 and devices 120, 130, and 140 may connect to the network 106 through wired, wireless, or optical connections.

In other embodiments, the client device 110 may be directly connected to the RMS 140. In one embodiment, the list of interfaces includes the software running on the E-HealthKEY and the MedicAlert website. In other embodiments, access may include partner Web sites and other devices, e.g. advanced static memory devices and mobile phones.

Examples of client devices 110 are static memory devices, personal computers, personal digital assistants, mobile phones, digital tablets, laptop computers, Internet appliances, and other processor-based devices. In general, a client device 110 may be any suitable type of processor-based platform that is connected to a network 106 and that interacts with one or more application programs. The client device 110 can contain a processor 112 coupled to a computer readable medium, such as memory 114. Client devices 110 may operate on any operating system capable of supporting a browser or browser-enabled application, such as Microsoft® Windows® or Linux. The client device 110 is, for example, a personal computer executing a browser application program such as Microsoft Corporation's Internet Explorer™, Netscape Navigator™, Mozilla Firefox, Apple Safari™, the Opera Web Browser, and/or open source browsers.

The NHR System 100, as shown in FIG. 1, permits the patient to manage or direct management of his or her healthcare information through an RMS 140. The patient's patient healthcare information (PHI) 126, 136 may be stored at a facility server 120, 130, which may be, for example, a physician or provider, such as a hospital (120) and a laboratory (130). Patients may also collect their own data, from a diary or by capturing data from in-home devices, such as a glucometer, a blood pressure machine, etc. This self-entered patient data and other information about the patient may also be stored in a database 150 associated with the RMS 140. A NHR Index 168 can be used to associate a patient's links to the locations of the PHI 126, 136 and can include summary information and other information relating to the patient stored on the RMS 140 or database 150. The NHR Index 168 can be stored memory 144 of the RMS 140 and/or the associated database 150.

The patient may either access his PHI or control access to his PHI through client device 110, which may be, for example, a personal computer residing at the patient's home. A person other than the patient who is interested in accessing the patient healthcare information may also access the system through client device 110, which in that case may be, for example, a personal computer residing in a physician's office, or an enterprise network located within a medical facility.

The present system can utilize clients and interfaces to services that provide information access and manipulation capabilities delivered using Service Oriented Architecture (SOA) to access to the RMS 140. The SOA approach gives healthcare providers the ability to mix and match best of breed applications to provide these functions. In one embodiment, the software for a client device provides:
A robust and consistent user interface for global access, and for affiliates that wish to use it;
International/local language versions for the non-English speaking world;
The ability to co-brand and change layouts for affiliates, partners (e.g. healthcare benefit payers) and other customers.
   In one embodiment, the architectural integrity of the Network Health Record System 100 revolves around the RMS 140.

In one embodiment, the RMS 140 is structured and tuned to support the function of providing for the patient or member with one composite health record across time and providers. Other systems may fulfill the roles of administrative functions, service or product orders, and billing. The RMS 140 supports a representation of a health record for each patient or member.

The RMS 140 may also incorporate the following services: entity identification and management to facilitate interfaces between entities; patient record and locator retrieval to facilitate exchange of data with the proper security and privacy safeguards in place; and common terminology services to facilitate the correct terminology mappings and provide semantic interoperability in healthcare.

An Information Model and a Terminology Model may be important to the RMS 140. In one embodiment, the RMS 140 may include functionality that requires the implementation of a reference model. Institutions such as the National Library of Medicine have built the “Unified Medical Language System” (UMLS), which is an aggregation of most terminology systems, and to some extent therefore, a reference model.

In one embodiment, a problem-list Information Model may be implemented in the RMS 140 and provide for a “whole person” view of the personal health record. A problem can consist of one or more conditions, which can be diagnosed in one or more ways, and can be treated with medications, procedures or activities that can be part of an overall care plan. In addition, the whole person view allows for the inclusion of other aspects of the patient's health, like vital sign tracking, wellness advice, reports and other documents, charts, images, scans, alerts and many other elements that make up the best possible data bank of personal health information.

Information Models, one for the database structure and another used as a reference model for information exchange with partners, deal with the way the data is structured in a system. For example one database may have a single field in which all the address data is entered as free text, and another database may use different fields for each element of the address, such as Street, Apt #, City, State and Zip Code. There may be two related information models used because the reference information model will be expected to change over time as business practices and medical knowledge evolve. The reference information model can be used to minimize the need to physically change the database structure, which is a time and money intensive process.

In one embodiment, the Terminology Model utilizes standard classification systems for medical conditions, medications and medical terminology that are international in scope, and moves the model away from proprietary coding, which adds overhead to any exchange of information with other systems or with emergency responders. The medical terminology model may be flexible and robust enough to handle new business requirements.

Terminology Models and code sets address the meaning of the information that is actually entered into the data fields. For simple, stable and relatively limited elements, like the abbreviations for the States, this is not a big problem, since the U.S. Post Office has set a standard that is in wide use in this country. However, one of the biggest challenges in the medical domain is the extensive, complex and evolving medical terminologies, both for use within a system like the RMS 140, and especially for information interchange with external partners and affiliates. The most obvious problem is the proliferation of synonyms for the same medical concept—one person says elevated blood pressure, another says hypertension and also says the equivalent in Hebrew. As with the reference information model, there may be two related terminology models—one used in the internal structure of the NHR and RMS 140, and the other, the reference Terminology Model used for mediating information interchange, which will also limit the impact of evolving terminology changes on the physical system.

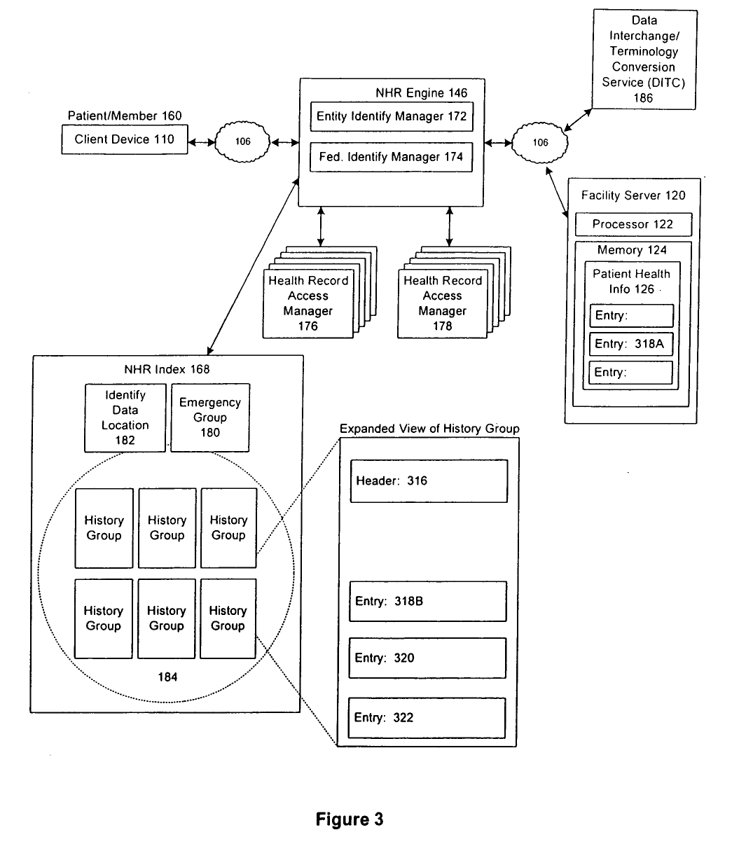

The requester can access the RMS 140 through the network 106 (e.g. the Internet) from client device 110 (e.g. a Web browser on the physician's personal computer). The NHR Engine 146 is located within the memory 144 of the RMS 140, but the NHR Engine 146 could be located in the database 150, or both. The NHR Engine 146 ascertains the identity of the requester as well as the patient whose information is being requested and determines whether the requester has been given permission by the patient to access the requested information. Such permission information may be stored either in the memory 144 or the database 150. In one embodiment, an Entity Identity Manager 172 (as shown in FIG. 3) performs the requisite identification, authorization, and authentication on the requests for access to the NHR. The Entity Identify Manager 172 (as shown in FIG. 3) can be located in the RMS 140 and may be part of the NHR Engine 146.

Assuming the requester has permission to access the requested PHI 126, 136, the NHR Engine 146 may access the NHR Index 168 maintained in database 150 to identify the location or locations of the facility servers where requested information is maintained. The NHR Engine 146 then accesses the identified facility servers through network 106 and, after negotiating a secured connection and verifying the identity of the patient as well as the availability of the requested PHI, obtains the requested PHI 126, 136, from the identified facility servers 120, 130. If the patient has multiple PHI 126, 136 records, the NHR Engine 146 ascertains which is current and correct. The NHR Engine 146 provides synchronization with other copies of PHI 126, 136 records. The requested PHI 126, 136 are delivered in standardized forms, for example in Change Control Record (CCR) using common delivery formats such as XML. The RMS 140 then assembles the requested PHI 126, 136, into an integrated package for presentation to the client device 110 through network 106. For integration, the RMS 140 may perform simple data alignments of the PHI 126, 136, to ensure common presentation of the data.

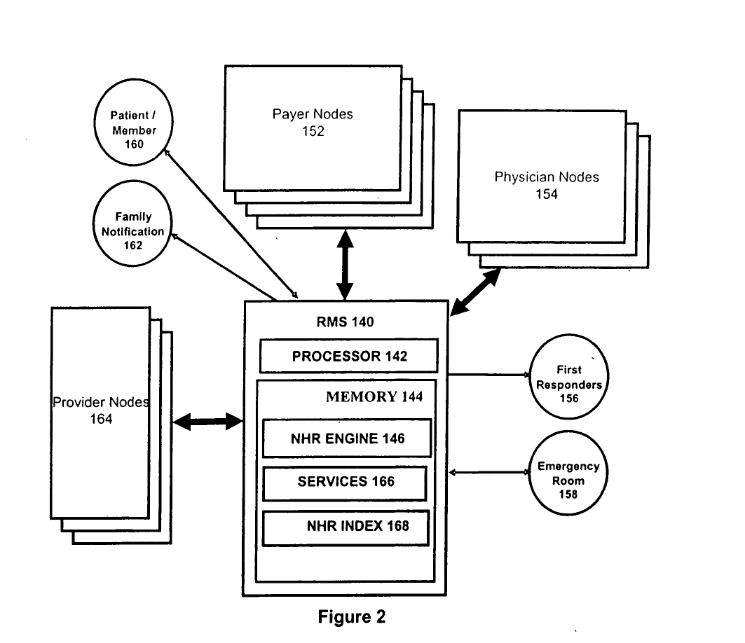

FIG. 2 is a block diagram showing selected aspects of an illustrative component environment of the NHR System 100 according to one embodiment. The NHR System 100 shown in FIG. 2 shows a patient or member 160 connected to an RMS 140. As shown in FIG. 1, the patient or member 160 can access the RMS 140 using a client device 110 via a network 106.

As discussed above, the RMS 140 may include the NHR Engine 146 and NHR Index 168. The RMS 140 may also include one or more services 166. As shown in FIG. 2, the services 166 are located within the memory 144 of the RMS 140, but the services 166 may be located in a separate database, such as database 150 shown in FIG. 1. Services 166 may include medical information services, group services, membership services, member contract services and a number of management services, such as security, web service, member identity and access, business rules, and connectivity.

The RMS 140 can provide connectivity to provider 164, payer 152 and physician 154 nodes, and to the first responders 156, emergency rooms 158 and family notification 162 services that are external to the RMS 140. The provider 164, payer 152, and physician 154 nodes may also reside on or be accessed via processor-based devices, such as servers. More specifically, the provider 164, payer 152, and physician 154 nodes may include or be accessed via processor-based devices, such as the facility servers 120, 130 shown in FIG. 1. For example, the physician node 154 can include the facility server 120 (shown in FIG. 1). In one embodiment and as shown in FIG. 1, the RMS 140 communicates with the various nodes and devices via a network 106, such as the Internet. First responders 156, emergency rooms 158 and family notification services 162 nodes may also reside on or be accessed via processor-based devices, such as servers.

The NHR System may also contain Emergency Response nodes so that it may respond to requests from properly identified, authenticated and authorized first responders 156 and emergency rooms 158 for information to be used for the benefit of a patient or member. The services 166 may contain one or more Emergency Groups containing the first responders 156 and emergency rooms 158 information, in order to properly identify and authenticate the request.

A response from the first responder 156 or emergency room 158 is presented to the RMS 140 via any of a number of devices, including telecommunications, Web browsers, and portable and mobile communicators. Once the request has been affirmatively vetted by the RMS 140, the appropriate and authorized personal, contact and medical information is made available to the requestor. In one embodiment, all requests are maintained in an audit log.

The services 166 may also include a family notification service. The family notification service may be invoked based on a number of conditions and any single notification may be implemented using the most appropriate protocol and device in combination. For example, the family notification may be made by e-mail, simple messaging service (SMS) on cellular devices, direct voice dialing, or other multimedia communications devices.

In one embodiment, the RMS 140 utilizes provider nodes 164, payer nodes 152, and physician nodes 154 to obtain PHI 126, 136 (shown in FIG. 1) about the patient or member 160. Provider nodes 164 may include healthcare delivery systems such as hospitals, clinics, emergency rooms; pharmacies that dispense prescription medications, either within a healthcare delivery system or independent from it; medical testing labs; PACS systems; and public health units. The provider nodes 164 may be housed in or include a facility server 120, 130, as shown in FIG. 1.

PHI 126, 136 (as shown in FIG. 1) that may be included from and released to provider nodes 164, payor nodes 152 and physician nodes 154 can be based on clinical observations from an exam, images and other readings from clinical instrumentation and medication administration reports including dosage information. PHI 126, 136 may also contain outcome information based on the results of treatments, procedures and care plans.

Payer nodes 152 may include health insurance carriers, MediCare, and state and local health plans in the U.S., and national health services in many other countries. PHI 126, 136 that is included from payer nodes 152 is primarily summarized from claims submitted by or on behalf of the patient or member. Since insurance claims are for the most part based on clinical encounters, prescriptions and other orders, and the administration of treatments and procedures, this information provides a timely, accurate and comprehensive snapshot of key elements of the insured patient's health record. The payer nodes 152 may be housed in or include a facility server 120, 130, as shown in FIG. 1.

Physician nodes 154 may be made up of various forms of connectivity to doctors' offices. Physician offices may use some form of electronic health record system. Most doctors are still using paper files that are physically filed in their office. The location, tracking and management of these physical files may be automated, and can be part of the connectivity at a particular node. In addition, almost all physician offices use some form of electronic claims submission system, so this can be used to capture some of the clinical data for insured patients. The physician nodes 154 may be housed in or include a facility server 120, 130, as shown in FIG. 1. Access to the physician nodes 154 may require the widest variety of approaches to establish a viable presence on the network supporting the NHR.

Each node 164, 152, and 154 may have its own set of requirements for information exchange. One embodiment of the present invention utilizes emerging standards for interoperability services, for example using the UMLS thesaurus, to provide the “plug and play” capability in order to enable the NHR System to embrace the most comprehensive spectrum of nodes 164, 152, and 154.

The patient or member 160 of the NHR System is the source of requests for inclusion or release of any PHI 126,136 (shown in FIG. 1). Membership is a notion that is supported by the NHR Index 168 and RMS 140, along with the concepts of member status, a member contract, member services and member associations. The member 160 is able to specify the nodes that will provide information that is included and released from the NHR Index 168 using any available client device 110 as a means of communication.

FIG. 3 illustrates the use of Identity and Access management (IDM) in the NHR System. In one embodiment, IDM is performed by the NHR Engine 146 and ensures that actions on data are only allowed where explicitly granted. For example:
User A can perform action B on Member C's data D, were D is a subset, chosen by C, of all C's data E.
   The repercussions of the above are that any solution should be able to check at runtime if any operation B is allowed on the subset D.

As shown in FIG. 3, the patient or member 160 via the network 106 uses the client device 110 to connect to the NHR Engine 146, which can contain an Entity Identity Manager (EIM) 172. The EIM 172 can perform the requisite identification, authorization and authentication on any and all requests for access to the NHR information. Once the connection and the particular request have been so vetted by the EIM 172, the EIM 172 allows operations on the information in the NHR index 168 as defined by the associated Health Record Access Manager (HRAM) 176. A HRAM 176, 178 can be a software application that accepts requests for access to data and returns an approval or denial. For example, Microsoft's Active Directory, or any LDAP compliant system may be used to implement a HRAM.

In one embodiment, the NHR Engine 146 accesses or makes a request for access to information that is only available in a PHI 126 stored in another location that is not pre-identified by the EIM 172, such as Facility Server 120. It is also possible that the NHR Engine 146 will be asked to provide access or information to a requester that is not part of the NHR domain. In these cases, the NHR Engine 146 can request identification, authorization and authentication of the request and the requester from the Federated Identity Manager (FIM) 174, as shown in FIG. 3. The purpose of the FIM 174 is to vet these requests with a Global ID service and with known and valid set of access criteria as provided by the associated HRAM 178.

It is also possible for the NHR Engine 146 to establish a direct link to an existing PHI 126 using a Data Interchange/Terminology Conversion Service (DITC) 186 that is known to the NHR System 100 (i.e., supported DITC). A DITC 186 is a translator service implemented via software that converts from one format, coding scheme, or language to another. DITC 186 may be used when the code sets supported by the NHR Engine 146 (e.g., ICD, HL7, etc.) do not match the coding of the Facility Server 120 where the PHI 126 is located. DITC 186 may be provided by various commercial service providers. In one embodiment, the NHR Engine 146 may access the requested PHI 126 through a DITC 186 via the network 106. In which case, the NHR Engine 146 via the network 106 makes a request to a Facility Server 120 for PHI 126. The request includes the code sets list and DITC list supported by the NHR Engine 146. If DITC 186 conversion is required because the coding for the NHR Engine 146 and the Facility Server 120 do not match, the Facility Server 120 compares the DITC service for the requested PHI 126 to the NHR Engine 146 supported DITC list, if no common DITC 186 service exist the Facility Server returns an error message to the NHR Engine 146. If a common DITC 186 service does exist, the Facility Server 120 sends the requested PHI 126 to the DITC 186 via the network 106 for conversion. The DITC 186 then translates the PHI 126 into the desired format and sends the translated PHI 126 to the NHR Engine 146 via the network 106. If no translation is necessary because the Facility Server 120 coding and the NHR Engine 146 supported code sets match, then the NHR Engine 146 may receive the requested PHI 126 located at Facility Server 120 directly via the network 106 without use of the DITC 186.

FIG. 3 further illustrates an embodiment of the NHR System 100 where the NHR Index 168 includes Data Location 182 identifying the location of the associated PHI at the various facilities, Emergency Group 180 containing first responders 156 and emergency rooms 158 information, and groupings of History Groups 184 that contain the patient's longitudinal health information. Within the History Groups 184, the span of the longitudinal health information is over the lifetime of the patient, and across all the touch points he or she has with healthcare systems. A History Group 184 is a set of related data, normally related by event, for example a hospital stay or a doctor office visit. The History Groups 184 information may be gathered from various locations including the provider 164, payer 152, and physician 154 nodes, or other facility servers 120, 130. As shown in FIG. 3, each History Group 184 is comprised of a header 316 for identification, and one or more entries 318, 320, 322. An entry may be either a discrete piece of the patient's health information or a reference to a discrete piece of the patient's health information. In one embodiment of the present invention, an entry 318B in the NHR Index 168 History Group 184 will be a link to and a brief summary of the associated full-scale record entry 318A located within the PHI 126 stored at the facility server 120.

Each Emergency Group 180 may also be comprised of a header for identification, and one or more entries containing the associated first responders 158 and emergency rooms 158 information. The Emergency Group 180 is used by the NHR System in case of an emergency to provide the Emergency Response service described-above.

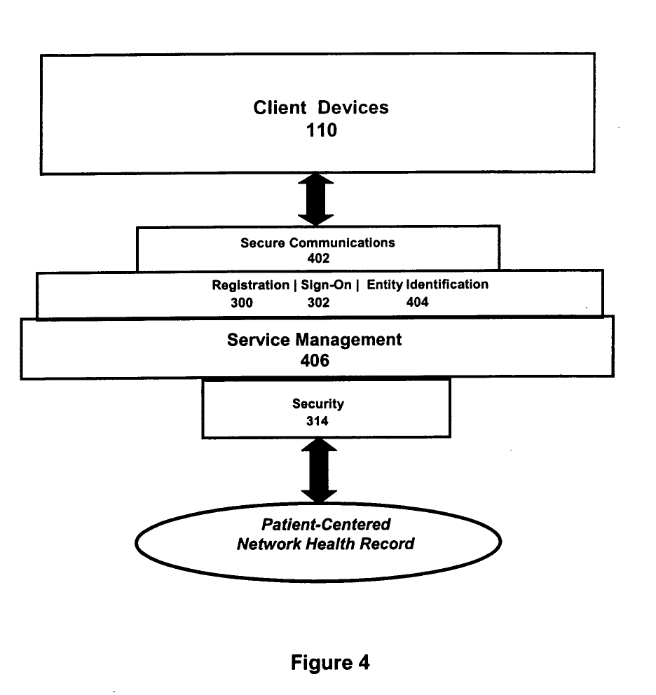

The NHR Index 168 content is determined via the NHR Engine 146 regulating the flow of data between each node in the network. FIG. 4 illustrates how the NHR System functions in one embodiment of the present invention. As FIG. 4 shows, the NHR System may be accessed by a client device 110 with a secure communications layer 402 connection. The patient through the client device 110 may perform various activities, such as Registration 300, Sign-on 302, and Entity Identification 404. In FIG. 4, the NHR Engine 146, which is within the context of an RMS 140, further verifies that the source of any request is properly authorized to access the NHR Index 168 information and that the originator of the request has the access permissions to perform the requested action. Once this internal Entity Identification 404 process is complete, the requester, through the client device 110, is granted the appropriate access to the enabled Service Management 406 interfaces of the NHR System. As shown in FIG. 4, there is also another Security layer 314 that interacts with the secure communications layer 402 to protect the actual data in the repository.

The secure communications layer 402 provides network protection and threat prevention. This solution includes standard network firewall services as well as application level security services. Stored information is protected from loss, so that once it is entered or received into the repository, the patient is guaranteed that it will never be lost. In addition, stored information is protected from unauthorized disclosure once it is in the repository or while it is in transit from a remote information source. Features to support security comprise digital signatures, auditing, and the Entity Identification 404 processes. Because of the critical need to maintain the security and privacy of healthcare information, the secure communications layer 402 is implemented whenever a request for information is received by the RMS 140 and whenever PHI is presented back to the requester at a client device 110.

The Entity Identification 404 processes provides functionality in the areas of access management, identity life cycle management, and directory services. The Entity Identification 404 processes enable the patient to establish a release of information policy, thereby granting permission to access records to such persons as family members, emergency response personnel, identified healthcare professionals such as organizations (e.g. MedicAlert, insurance providers, etc.), facilities (e.g. hospital, lab, pharmacy, etc.), and individuals (e.g. physician, pharmacists, other care-givers). Thus, when a request for information is received, the Entity Identification 404 processes are invoked to ascertain whether the requester has the necessary permissions. Valid permissions include Exist, View, Append, and Hide. Entity Identification 404 also insures that any additions and changes to the legal medical record conform to legal requirements. In addition, several features enable a permitted party to add information to a record. These permissions will enable:
A request by a patient,
Consent by patient to add information,
Automatic addition of information from a source that the patient has already authorized, and
Link information to allow a patient to link or point to information (along with any associated access or authorization information) that is stored at a facility server (e.g. 120, 130) location rather than holding the information in the repository.

Once properly identified and given permitted access, within Service Management 406, the requester (e.g. the patient), for example and without limitation, can:
Manage personal health information;
Manage personal health spending (HSA, HRA);
Add to the medical records by keeping a diary of diet and exercise regimen, symptoms, etc;
View trends (aggregates) in the captured data (blood pressure, weight, glucometer readings, etc.);
Request records, updates and corrections to information from other sources;
Review alerts and messages that have been received from medical personnel, such as drug interaction alerts;
Reconcile physician visits with insurance bills.
   In this manner, the NHR System enables a patient to create, manage, and maintain his or her NHR including healthcare information located at various facilities.

### NHR Creation

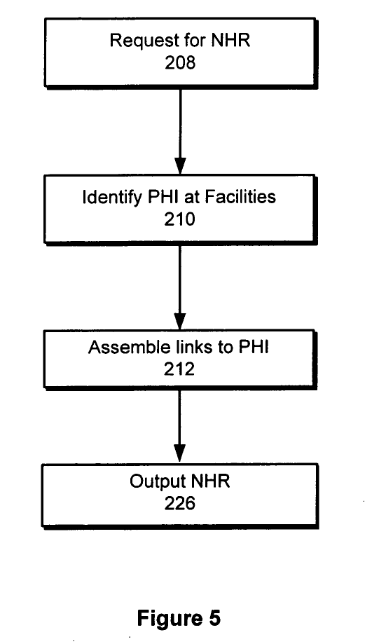

To create a NHR for a patient, the patient or member may use a client device to interact with the NHR system. FIG. 5 is a flowchart of how in one embodiment, a NHR is initially created. As shown in FIGS. 3 and 4 in conjunction with FIG. 5, through a client device 110 via the network 106 through a secure communications layer 402 the NHR Engine 146 receives a request 208 from a patient or member 160 to setup a NHR via a NHR Index 168.

As shown in FIGS. 1, 2, and 3 in conjunction with FIG. 5, the NHR Engine 146 (which can contain an EIM 172 and/or a FIM 174) located within the context of an RMS 140, via the network 106 the NHR Engine 146 identifies 210 the PHI 126, 136 associated with the patient via the payer nodes 152, physician nodes 154, and provider nodes 164 at various remote facility servers 120, 130. Each node 152, 154, and 164 may have its own set of requirements for information exchange through the network 106. Thus the NHR System 100 may utilize the UMLS thesaurus or other emerging interoperability services, to provide communications with the nodes 152, 154, and 164 housed in various facility servers 120, 130.

The RMS 140 via the NHR Engine 146 then assembles links 212 to the PHI 126, 136 at the facility servers 120, 130. If necessary, DITC 186 may be used to translate the data passed from the facility server 120, 130 to the NHR Engine 146, so the NHR Engine 146 may assemble links 212 to the associated PHI 126, 136 located at the facility servers 120, 130. The NHR Engine 146 assembles links 212 by creating a NHR Index 168 containing Data Location 182 and the links may be grouped within the NHR Index 168 as History Groups 184, wherein an entry 318B may contain a link and a summary of the associated full-scale record entry 318A of the PHI 126 located at the facility server 120. The NHR Index 168 may contain various links to PHI 126, 136 and via the NHR Engine 146 these links will be governed by the EIM 172 and/or the FIM 174 to allow operations on the information in the NHR Index 168 as defined by the associated HRAM 176, 178.

The RMS 140 then outputs 226 the NHR Index 168 through a secure communications layer 402 and the network 106 to the client device 110 for display to the client or member 160. The client or member 160 via the client device 110 will be presented with the NHR Index 168, essentially a record containing various links to associated PHI 126, 136 and may contain summary information regarding the patient and the health information. The NHR System 100 may not store the complete PHI 126, 136, but instead the NHR Index 168 may contain links to the PHI 126, 136 as stored at the remote facility servers 120, 130.

### PHI Retrieval

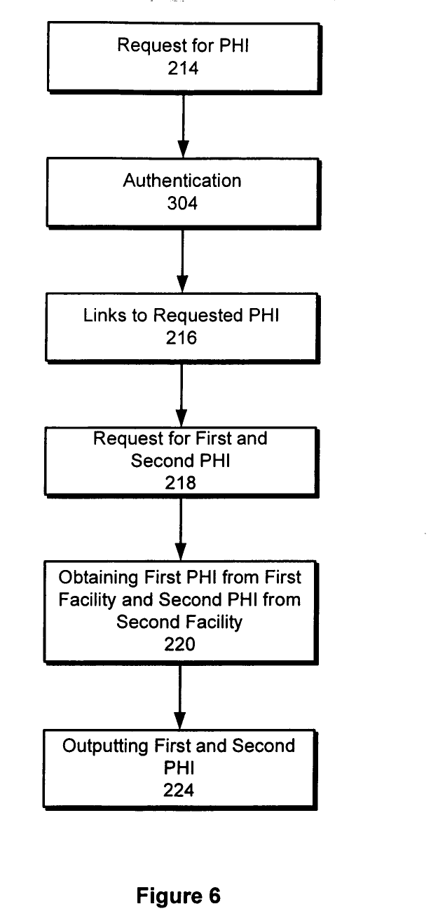

To view specific details of a PHI entry on a NHR, the patient or member may select the link on the NHR Index 168 and drill-down from there. FIG. 6 is a flowchart of how in one embodiment, a user can retrieve PHI details from a NHR Index 168. As shown in FIGS. 3 and 4 in conjunction with FIG. 6, from a client device 110 via the network 106 through a secure communications layer 402 the NHR Engine 146 nestled within the RMS 140, receives a request 214 from a patient or member 160 for PHI 126,136 associated with the patient. The secure communications layer 402 provides protection of information from unauthorized disclosure and loss via the network 106.

As shown in FIG. 4 in conjunction with FIG. 6, the NHR Engine 146 through an authentication 304 process, further determines (following the secure communications layer 402) via an internal Entity Identification 404 process whether the requesting patient or member 160 has authorization to access the PHI 126, 136. The Entity Identification 404 process verifies the requesting patient or member 160 is authorized according to the associated patient's release of information policy as defined by the patient him/herself through the access management services (located within the Entity Identification 404 processes). For example, a patient can define his/her release information policy upon initial registration for the NHR System service.

As shown in FIGS. 1 and 3 in conjunction with FIG. 6, if authorized, the NHR Engine 146 outputs 216 links to requested PHI 126, 136 at various remote facilities 120, 130 through the secure communications layer 402 out to the client device 110 via the network 106. The secure communications layer 402 may be implemented whenever a request for information is received and whenever PHI is presented back to the patient or member 160 at the client device 110. The patient or member 160, if authorized, will have drilled down one layer further into the NHR index 168 regarding the requested PHI 126, 136.

The requesting patient or member 160 via a client device 110 then selects a particular link to view PHI 126, 136 details (i.e., drill-down to specific details of the requested record, for example, details of all treatment for a sprained ankle). Through the network 106 via a secure communications layer 402 the NHR Engine 146 receives 218 this request for a first and second PHI 126, 136. The NHR Engine 146 may further determine via an internal Entity Identification 404 process whether the requesting patient or member 160 has authorization to access the PHI 126, 136 details.

The NHR Engine 146 via its EIM 172 and FIM 174 and the associated HRAM 176, 178 through the network 106 and a secure communications layer 402, the NHR Engine 146 obtains 220 the first PHI 126 from the first identified facility server 120 and the second PHI 136 from the second identified facility server 130. If necessary, DITC 186 may be used to properly convert the PHI 126, 136 retrieved from the first and second facility server 120, 130 into a supported format before transmittal to the NHR Engine 146.

Then the RMS 140 assembles the requested PHI 126, 136, into an integrated package (e.g., simple data alignment) and outputs 224 the first and second PHI 126, 136 to the authorized requesting patient or member 160 via the client device 110 through a secure communications layer 402 and the network 106. The patient or member 160 is presented with a detailed PHI record via the client device 100. The detailed PHI record is not stored by the NHR System 100, but is a mirror image of the PHI 126, 136 as actually stored at the remote facility servers 126, 136.

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

We claim:

1. A method for setup of a network health record associated with a patient comprising:
receiving a request from a requester to setup a network health record at a repository and management system;
identifying patient healthcare information associated with the patient at a plurality of facilities remote from the repository and management system; and
assembling links to the patient healthcare information at the facilities.

2. The method of claim 1, further comprising:
outputting links to the patient healthcare information at the facilities.

3. The method of claim 1, further comprising:
ascertaining and validating the identity of the requester.

4. The method of claim 1, further comprising:
determining whether duplicate patient healthcare information is stored at a plurality facilities; and
synchronizing links to the most current patient healthcare information at the facilities.

5. A method for providing access to patient healthcare information associated with a patient comprising:
receiving a request from a requester for patient healthcare information associated with the patient at a repository and management system;
determining whether the requester has authorization to access the patient healthcare information;
outputting links to the authorized patient healthcare information at a plurality of facilities;
receiving a request for a first and second patient healthcare information;
obtaining the first patient healthcare information from a first facility and the second patient healthcare information from a second facility; and
outputting the first and second patient healthcare information.

6. The method of claim 5, further comprising:
converting disparate formats in which the first and second patient healthcare information is stored into an integrated format.

7. The method of claim 5, further comprising:
interacting with the authorized requester to determine preferred language; and
translating the output format in which the first and second patient healthcare information is stored into the authorized requester's preferred language.

8. The method of claim 5, further comprising:
interacting with the patient to obtain approval to release the first and second patient healthcare information to a third-party.

9. A patient controlled healthcare information management system comprising:
a plurality of facilities, for storing patient healthcare information; and
a repository and management system in communication with the facilities, the repository and management system comprising a network health record, wherein the network health record comprises links to a patient's patient healthcare information stored at the facilities, and the repository and management system is remote from the facilities and enables a patient to manage the patient's patient healthcare information stored at the facilities.

10. The system of claim 9, further comprising:
a communication network, enabling communication among and between the facilities and the repository and management system.

11. The system of claim 9, further comprising:
one or more requester devices.

12. The system of claim 9, wherein the network health record further comprises:
one or more history groups, wherein the history groups contain a patient's longitudinal patient healthcare information over the lifetime of the patient.

13. The system of claim 12, wherein each history group comprises:
a header for identification; and
one or more entries, each entry comprising a discrete piece of a patient's patient healthcare information or a reference to a discrete piece of a patient's patient healthcare information.

14. The system of claim 9, wherein the repository and management system further comprises:
a network health record engine, that enables a patient to provide secure access to selected patient healthcare information to a requester.

15. The system of claim 9, further comprising:
a security process, wherein the security process protects the patient's patient healthcare information.

16. The system of claim 15, further comprising:
an entity identity manager, wherein the entity identity manager verifies that a requester, the source of a request for access to or for action to a patient's patient healthcare information has proper authorization to access a patient's patient healthcare information and proper access permissions to perform a requested action.

17. The system of claim 16, further comprising:
a federated identity manager, enabling identification, authorization, and authentication of a request by a requester that is not authorized by the entity identity manager.

18. The system of claim 9, wherein the network health record further comprises:
one or more emergency groups.

19. The system of claim 15, wherein a emergency group further comprises:
first responders information; and
emergency rooms information.

20. The system of claim 9, wherein the network health record further comprises:
a family notification service to notify identified family member if set condition occurs.
